(19) United States
(12) Patent Application Publication
(10) Pub. No.: US 2003/0038719 A1
(43) Pub. Date: Feb. 27, 2003

(54) System for detecting the occupancy status of a seat

(76) Inventors: Bernhard Mattes, Sachsenheim (DE); Heinz Pfizenmaier, Leonberg (DE); Michael Thiel, Leonberg (DE); Michael Mahler, Leinfelden-Echterdingen (DE); Juergen Von Hagen, Wolfratshausen (DE); Jens Haala, Backnang (DE); Werner Wiesbeck, Kelten-Ellmendingen (DE)

Correspondence Address: KENYON & KENYON, ONE BROADWAY, NEW YORK, NY, 10004, US

(21) Appl. No.: 10/153,539

(22) Filed: May 22, 2002

(30) Foreign Application Priority Data
May 22, 2001 (DE) 101 24 915.2-35

(51) Int. Cl. G08B 13/00

(52) U.S. Cl. 340/541; 340/425.5; 340/573.1; 701/45; 180/271

(57) ABSTRACT

A system for detecting the occupancy status of a seat is described. One embodiment comprises at least one transmitter of a high-frequency electromagnetic signal and at least one receiver that receives the electromagnetic signal. The receiver determines the intensity of the received signal compared to at least one threshold value, which indicates whether an occupant or part of an occupant is located between a transmitting antenna and a receiving antenna. In a specific embodiment, a single transmitter and a plurality of receivers are used to determine information about the occupancy status and the position of the occupant within the seat, and the information is output to a triggering system for use in the deployment of an occupant restraint system.

### FIELD OF THE INVENTION

The present invention relates to a system for detecting the occupancy status of a seat, for example in a motor vehicle as part of a occupant restraint system.

### BACKGROUND OF THE INVENTION

In order to avoid unnecessary deployment and optimize the deployment of motor vehicle restraint systems, for example front airbags, side airbags and seat-belt tightening systems, it is desirable to first determine if a particular seat that is associated with the deployable restraint system is occupied. In addition, it is desirable to be able to determine how a person is sitting on a particular seat, for example in an upright position, which is considered herein to be the ideal sitting position, or in a different, non-upright position, which may cause the deployment of a particular restraint system or a type of deployment of a particular restraint system to be dangerous or ineffective.

Furthermore, it is desirable to determine the position of an occupants's head, which may allow the restraint system to accommodate the deployment to the height of the occupant. In this case, a system of simple design that can be easily monitored, installed and replaced is particularly desirable.

One system is disclosed by published European Patent Application No. 1 002 690, which describes a detector built into the sitting area of a seat that changes, in response to the weight of an occupant, its distance from a transmitter built into the seat. An oscillator emits a weak high-frequency wave via the antenna and the distance between the conductive part and the antenna is determined by the intensity of the signal voltage. For instance, the voltage is detectable and analyzable for its level to determine whether or not the seat is occupied. However, this system is rather complicated and requires permanent installation of the conductive part in the seat area. Also, the signal corresponds to any weight placed within the seat, and cannot determine the seating position, height or inclination of the occupant.

It has also been proposed that capacitance electrodes be provided in the seat back or in the seat area and the change in capacitance be analyzed by measuring a change in the electrical field. It has also been proposed that a plurality of pressure sensors be provided in the seat area and/or in the seat back (Japanese Patent B-2669656).

Optical systems reminiscent of surveying systems using infrared lasers have also been proposed (these systems being capable of also detecting the head position). All these systems are also extremely complicated and therefore also costly and subject to failure.

### SUMMARY OF THE INVENTION

The present invention is based on the effect that an occupant's body has on a high frequency signal that is transmitted through the occupant's body. For instance, a signal passing through a car seat will have a more intense signal than a signal passing through both an occupant and the car seat. The presence of a body between a transmitter and a receiver reduces the intensity (or strength) of the signal received by a receiving antenna from the transmitting antenna. The degree of reduction in the signal intensity is dependent on the position of the body, which can be directly between the transmitter and the receiver or only partly between the transmitter and receiver.

For an embodiment of the present invention to detect the occupancy status of a seat, neither the transmitter nor the receiver need to be integrated into a seat to be monitored. In one embodiment only a single transmitter is provided for detecting the occupancy a plurality of seats and/or for a plurality of areas of a seat to be monitored. Furthermore, upon failure of any particular transmitter, if no signal is received from the transmitter by one or more receivers, then the system concludes that the transmitter has failed.

In addition, one embodiment of the invention allows the system to detect whether the occupant's body, if present, is in a fully upright position. In another embodiment the position of the occupant's head is detected.

Therefore, the present system can account for the occupant's head and body position as part of the occupancy status not only to avoid unnecessary or dangerous deployment of a restraint system, but to optimize any deployment of the restraint system during an accident, for example, by controlled time-staggered ignition of the triggering charges of front airbags, side airbags, and the like.

### BRIEF DESCRIPTION OF THE DRAWING

FIG. 1 shows a schematic illustration of one embodiment of a system for detecting the occupancy status of a seat, according to the present invention.

### DETAILED DESCRIPTION

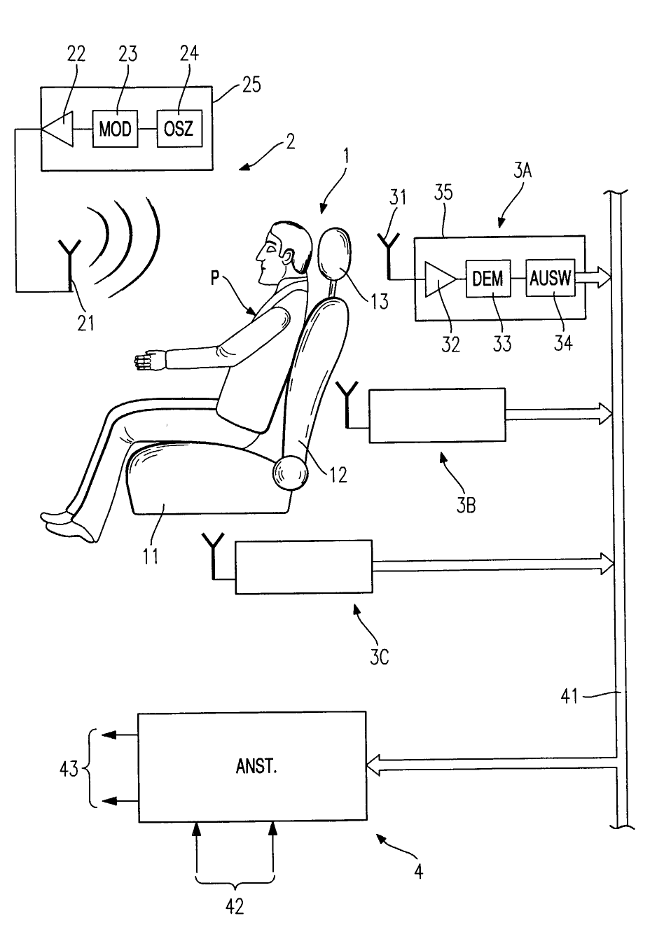

In one embodiment of the invention, the system for detecting the occupancy status of a seat is used for determining the position of an occupant in the seat of a motor vehicle, which has at least one seat 1, which may be occupied by a person P who is an occupant of the vehicle, for example a passenger or a driver. This embodiment of the invention comprises at least one transmitter 2 and at least one receiver. For example, FIG. 1 illustrates a single transmitter 1 and three receivers 3A, 3B, and 3C. The seat of FIG. 1 has a seat base 11, a seat back 12, and a head rest 13.

In the embodiment illustrated in FIG. 1, the transmitter 2 comprises a transmitting antenna 21, an amplifier 22, a modulator 23, and an oscillator 24. Alternatively, the modulator can be omitted. In one embodiment, the amplifier, modulator, and oscillator are housed in a module housing 25. In the embodiment of FIG. 1, a receiver comprises a receiving antenna 31, an amplifier 32, a demodulator 33, and an analyzing circuit 34. Alternatively, the demodulator in the receiver is omitted if the modulator in the transmitter is omitted. In one embodiment, the amplifier, demodulator, and analyzing circuit are housed in a receiving module housing 35. In the embodiment of FIG. 1, the three receivers 3A, 3B, and 3C each have the same design.

In operation of the embodiment of FIG. 1, the transmitting antenna 21 emits an electromagnetic signal when the oscillator 24 is activated. The electromagnetic signal is transmitted to and is received by each of the three antennas, and is analyzed in each of the receivers by the analyzing circuit 34 to determine the signal intensity of the received signal. If an occupant, e.g. person P, or a part of an occupant is situated between the transmitting antenna 21 and the receiving antenna 31, the signal intensity received by the particular receiver is attenuated compared to a signal that is transmitted to the receiver without such attenuation by the body of an occupant.

In one embodiment, the analyzing circuit 34 analyzes the attenuation of the signal intensity, and the receiver outputs a corresponding information signal, which, alternatively may be further processed. For example, in one embodiment, the information signal is transmitted directly to a triggering system 4. Alternatively, the information signal is transmitted via a data bus 41. In one embodiment, triggering system 4 is used for generating output signals 43 for deploying an occupant restraint system, based on the information signals output by each of the receivers and additional information signals 42. For example, the additional input signals 42 include, but are not limited to, signals concerning the actual speed of the vehicle, the relative velocity with respect to another vehicle, and the buckled/unbuckled status of safety belts. For example, the output signals 43 are used for activating seat-belt tightening systems and various deployment charges for particular airbags.

In one specific embodiment, the analyzing circuit 34 is used first to determine whether an occupant's body is located between a transmitting antenna 21 and a receiving antenna 31, and the analyzing circuit 34 detects and transmits an information signal when the received signal intensity is less than a first threshold value, which is set to indicate when at least a portion of an occupant's body is present between the transmitting antenna and the receiving antenna.

For example, when an occupant's body is only partially situated between a transmitting and receiving antenna, the signal intensity attenuation is less than when the occupant's entire body is positioned directly between the transmitting and receiving antennas. In one antenna configuration of this embodiment, when the occupant's entire body is positioned directly between the transmitting and receiving antennas, the occupant is ideally sitting in an upright position in the seat. Thus, if the signal intensity attenuation is particularly great, for example the received signal intensity is less than a second threshold value, then this is an indication that the occupant's body is sitting ideally upright in the seat. In such an embodiment, the analyzing circuit 34 determines not only whether an occupant is in the seat but also an indication of the position of the occupant's body. In one specific embodiment, the position of the head can be determined in relation to the head rest, for example.

If a transmitter 2 fails, the signal intensity received from the particular transmitter by each receiver is zero; therefore, failure of the transmitter can be determined by the analyzing circuit 34. To prevent electromagnetic noise in the environment from being detected as an operating transmitter signal by the analyzing circuit, when in fact the transmitter has failed, one embodiment of the invention detects a transmission failure by comparing the received signal intensity to a very low third threshold value. A very low third threshold value is selected to be a value of signal intensity greater than the electromagnetic noise received by a receiving antenna, but less than lowest signal intensity received by a receiver after attenuation by any occupant's body being directly between the transmitter and the receiver.

In an alternative embodiment, a modulator 23 modulates the transmitted signal to a specific modulation pattern and a demodulator 33 discriminates and demodulates the signal, which prevents electromagnetic noise from being interpreted as a signal from a transmitter. Therefore, failure of the transmitter is detected by the analyzing circuit, when no modulated signal is received from the transmitter.

For example, FIG. 1 shows that the transmitter 2 and the receivers, 3A, 3B, and 3C, are not integrated into the seat 1, which allows for easy servicing, replacing, and retrofitting.

In one specific embodiment, the circuit design is relatively simple: the analyzing circuit 34 comprises a measuring circuit for measuring the received signal intensity, a comparison circuit for comparing the received signal with at least one threshold value, and an output circuit for emitting information signals, wherein the information signals indicate, for example, the particular status of the threshold comparison as an indication of occupancy status of the seat to the triggering system 4 via a data bus 41. In one embodiment, the information signal on the data bus contains information regarding the threshold status, for example if the signal intensity is above or below at least one threshold value as determined by the comparison circuit, the receiver address, and/or the receiver position. In yet another alternative embodiment, the information signal contains assignment information about the receivers, wherein the information on the data bus from each of the receivers, for example the three receivers, 3A, 3B, and 3C shown in FIG. 1, are associated with the seat 1, and this information signal is used by the triggering system to accurately determine the position of an occupant's body by integrating the data from the three receivers, which allows the triggering system to deploy the occupant restraint system in an appropriate manner, if necessary.

Alternatively, a greater or lesser number of receivers than three are arranged within a vehicle to detect the position of an occupant's body in a seat. For example, many separate receivers may be arranged in a head rest 13 to detect the exact position of the occupant's head.

In an alternative embodiment, sensors are incorporated in more than one seat in a vehicle, and each seat is associated with corresponding receivers with a single transmitter 2. Alternatively, a plurality of transmitters transmit signals within the vehicle.

In yet another alternative embodiment, a single receiver receives the transmitted signal and compares the intensity to the first threshold value and the third threshold value. In this embodiment the information signal from the analyzing circuit is used to determine if an occupant occupies a passenger compartment or in some other area, for example.

The selection of a particular transmission signal intensity and transmission frequency may be varied for the present invention, and a broad range of intensities and frequencies are possible, depending on local legal requirements, for example. In one specific embodiment, a modular design allows upgrades and/or modifications to be performed in a simple manner. For example, in one specific embodiment, the analyzing circuit 34 is a replaceable submodule, which also in this respect allows easy adaptation to the respective application.

What is claimed is:

1. A system for detecting an occupancy status of a seat, comprising:
a transmitter having an oscillator, an amplifier, and a transmitting antenna, and wherein the oscillator, the amplifier, and the transmitting antenna, wherein the transmitter transmits a signal; and
a receiver assigned to the seat, the receiver having a receiving antenna and an analyzing circuit, wherein the analyzing circuit measures a received signal intensity and emits an information signal derived from the received signal intensity, the information signal at least indicating the occupancy status.

2. The system according to claim 1, wherein the analyzing circuit compares the received signal with a first threshold value and, if the received signal intensity is less than the first threshold value, the information signal indicating occupancy of the seat is emitted.

3. The system according to claim 2, wherein the analyzing circuit additionally compares the received signal intensity to a second threshold value and, if the received signal intensity is lower than the second threshold value, emits the information signal which indicates a failure of the transmitter.

4. The system according to claim 1, wherein the transmitter further comprises a modulator, and the receiver further comprises a demodulator adjusted to the modulator.

5. The system according to claim 1, further comprising a plurality of receivers assigned to the seat, wherein the information signal from each of the receivers is further processed to determine at least one of the occupancy status and a position of an occupant in the seat.

6. The system according to claim 5, wherein a single transmitter is provided for a plurality of seats, and wherein each seat has a plurality of receivers assigned to the seat.

7. The system according to claim 2, further comprising a triggering system for deploying a restraint system for the seat, wherein the triggering system deploys the restraint system if the occupancy status indicates that the seat is occupied.

8. The system according to claim 7, wherein the analyzing circuit determines that the seat is occupied if the received signal intensity is less than the first threshold value by a first deviation, and wherein the analyzing circuit determines that the seat is occupied and an occupant is sitting in an upright position if the received signal intensity is one of less than the first threshold value by a second deviation and less than a third threshold value, and wherein the analyzing circuit outputs the corresponding information signal to the triggering system.

9. The system according to claim 8, wherein the triggering system utilizes additional detectable parameters to make a decision regarding triggering of the restraint system.

10. The system according to claim 1, wherein the transmitter and the receiver are modular.
